(19) United States
(12) Patent Application Publication
(10) Pub. No.: US 2009/0175309 A1
(43) Pub. Date: Jul. 9, 2009

(54) INDIVIDUAL SEGMENT COOLING DEVICE FOR THE ELECTRODES OF A METALLURGICAL FURNANCE

(76) Inventors: Horst-Dieter Borgwardt, Dorsten (DE); Karl-Heinz Kummer, Duisburg (DE); Christian Kempe, Duisburg (DE); Siegfried Bender, Duisburg (DE)

Correspondence Address: ABELMAN, FRAYNE & SCHWAB, 666 THIRD AVENUE, 10TH FLOOR, NEW YORK, NY, 10017, US

(21) Appl. No.: 11/990,325

(22) PCT Filed: Jul. 11, 2006
(86) PCT No.: PCT/EP2006/006746

§ 371 Date: Feb. 24, 2009

(30) Foreign Application Priority Data
Aug. 10, 2005 (DE) 10 2005 037 749.1

(51) Int. Cl. H05B 7/10

(52) U.S. Cl. 373/94

(57) ABSTRACT

In a cooling device for electrodes of a metallurgical furnace, such as reduction furnace, electrical arc furnace, induction furnace, etc., which surrounds the electrodes and consists of individual segments (2, 3, 4, 5), at least one individual segment (2, 3, 4, 5) is formed with at least one hinge (7, 8). In addition, the invention relates to a method of pivoting away at least one individual segment (2, 3, 4, 5).

The present invention relates to a cooling device for electrodes of a metallurgical furnace, such as reduction furnace, electrical are furnace, induction furnace, etc., which surrounds the electrodes and consists of individual segments.

DE 31 48 606 A1 discloses a method of facilitating maintenance and replacement of contact jaws of electrodes of an electrical arc furnace. At that, the lower part of the support jacket of the contact jaws, which is formed of two part releasably connected with each other, telescopically raises on the upper part, whereby the contact jaws secured on the lower part are brought to a position above the furnace arch. Further, there, a corresponding device is described.

DE 36 30 861 C2 discloses an electrode arrangement for electrical arc furnace or reduction furnace with several electrodes extendable through the furnace cover with cylindrical capsules, which are concentrically arranged relative to individual electrodes, and with current feeding devices that along a portion of their length, extend as current tubes parallel to the electrodes, with their axis extending over cylinders concentric with the electrodes, surrounding a portion of the cylinder circumference and at the end of which adjacent to the furnace bottom, contact jaws, which can be pressed against the electrodes, are arranged. Each of the capsule has at least two openings extending longitudinally at least over a portion of their circumference with respect to their width. In these openings, current tube pieces of current feeding devices, which run coaxially to the capsules, are arranged and are partially combined by embedding, casting around and the like, substantially sealing the openings. The capsules, adjacent to the two openings are adjacent toward each other.

An electrode arrangement for electrical are furnace or reduction furnace is disclosed in DE 21 25 773 C3. Current feeding parts, in particular current conductors, holding parts and the like, which are located in the furnace region, are protected by a double-wall, water-cooled, cooling jacket arranged coaxially with the electrode. The cooling jacket extends up to the holding ring and can be removed therefrom. The cooling jacket is divided into upper cylindrical part and lower cylindrical part by a plane extending transverse to its axis. The lower part is divided in cooling screens releasably connected with each other and through which cooling medium flows.

In this way, the electrodes are surrounded by the cooling device beneath a hood with gas vents up to the current feeding brackets. The removable cooling screen provides for an easy access to the locking device or current feeding brackets in case of repair.

The cooling screens should be individually formed, being handled by loosening screws, tightening of bolts, using a lifting device, or the like. These time-consuming methods adversely influences the output, because a furnace is run continuously during an operation, and has an availability of about 97% per year. During the release and removal of the cooling screens, also, the water-conducting parts can be damaged.

The object of the invention is to so improve the known cooling device that the access to electrodes is simplified, and the above-mentioned drawbacks are eliminated. In addition, with the improved cooling device, the availability of the furnace is improved.

The object of the invention is achieved in that in the cooling device according to the preamble of claim 1, at least one individual segment is formed with at least one hinge.

Further embodiments of the cooling device follow from the subclaims.

The invention also relates to a method of pivoting away at least one individual segment.

Further embodiments of the method follow from the respective subclaims.

The decisive advantages of the inventive cooling device consists in that the individual element or elements can be moved away from electrodes by simply pivoting them away. A lifting device or the like is not needed. The individual segments need not be temporarily removed, but rather remain secured to the electrodes or their lifting devices, while insuring access to the electrodes.

The cooling circuit is retained as the cooling water feeding or removing takes place over flexible conduits. Those are so arranged that they do not hinder the pivotal process or limit the same.

The foregoing improvements reduce the furnace down time as the maintenance time is shortened.

An embodiment of the invention will now be described with reference to very schematic drawings.

The drawings show:

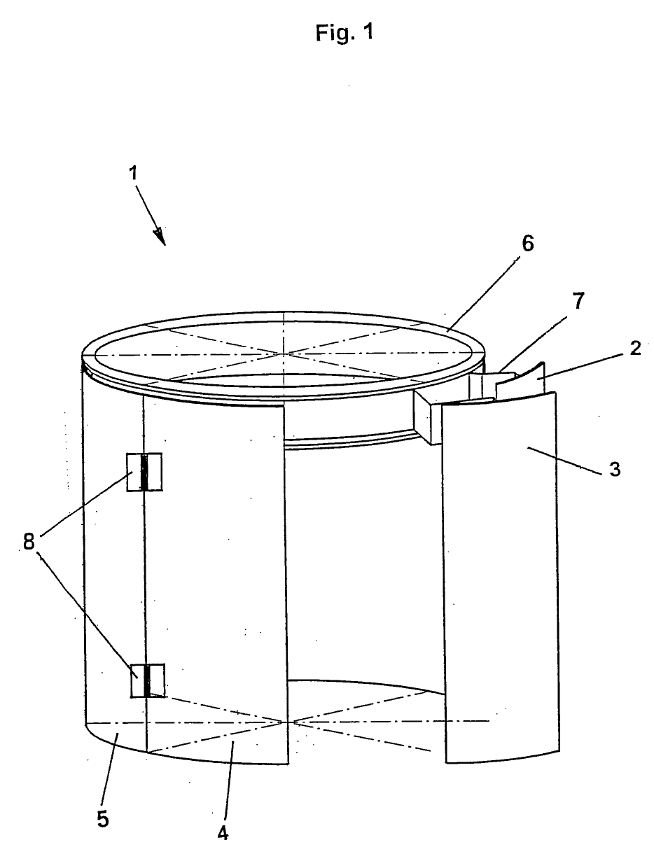

FIG. 1 a perspective view of a cooling device consisting of individual segments; and

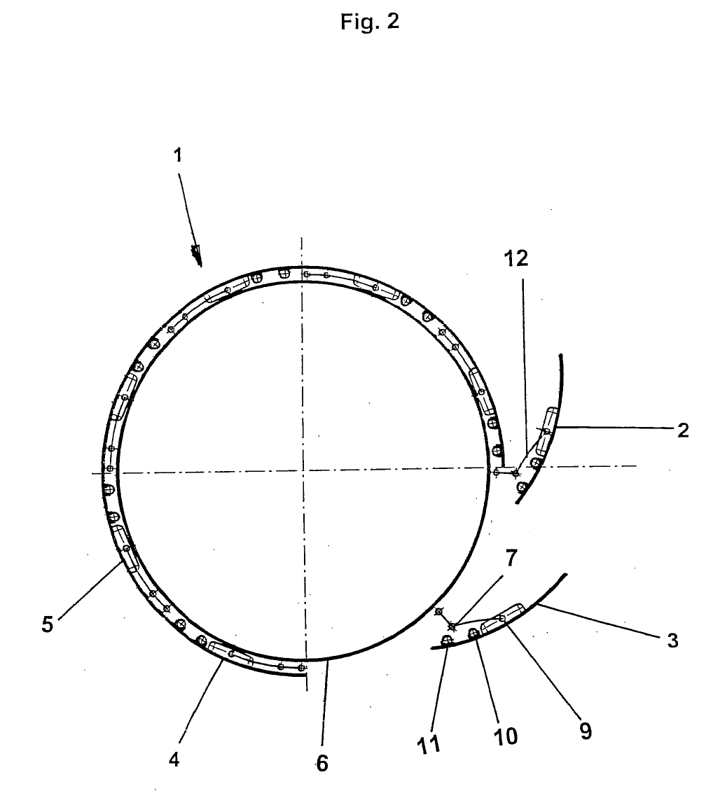

FIG. 2 a plan view of the inventive cooling device.

In FIG. 1, a cooling device 1, which consists of a plurality of individual segments 2, 3, 4, 5, is shown. The individual segments 2, 3, 4, 5, are separately secured on a suspension frame with at least one hinge 7. Dependent on the size and weight of the individual segments 2, 3, 4, 5 further hinges 7 can be used. As it would be shown, the individual segments 2, 3 are pivoted away from the electrodes (not shown) with the hinges 7.

Each individual segments 2, 3, 4, 5 can be pivoted with a hinge separately. However, there still exists a possibility to pivotally connect two adjacent individual segments 4, 5 with one or more hinges 8, with the individual segment 7 being connected with the suspension frame 6 by a hinge 7. Alternatively, the individual segment 5 can be connected with a further individual segment by a hinge 8.

FIG. 2 shows a plan view of the cooling device 1 in which all of the individual segments 2, 3, 4, 5 are separately connected with the suspension frame 1 by hinges 7. The individual segments 2, 3, 4, 5 have, to this end, each a pivot joint with which a hinge 7 is connected.

Each individual segment 2, 3, 4, 5 is provided with at least one inlet 10 and at least one outlet 11. Those are connected with cooling water circuit by flexible conduits (not shown). Alternatively, two adjacent individual segments 2, 3, 4, 5 can have a common cooling water circuit.

If the individual segments 2, 3, 4, 5 should be pivoted toward electrodes by a large distance so that at least one hinge web 12 can be formed telescopically.

### LIST OF REFERENCE NUMERALS

1. Cooling device
2. Individual segment
3. Individual segment
4. Individual segment
5. Individual segment
6. Suspension frame
7. Hinge
8. Hinge
9. Pivot joint
10. Cooling water inlet
11. Cooling water outlet
12. Hinge web

1. A cooling device (1) for electrodes of a metallurgical furnace, such as reduction furnace, electrical arc furnace, induction furnace, etc., which surrounds the electrodes and consists of individual segments (2, 3, 4, 5),
characterized in that
at least one individual segment (2, 3, 4, 5) is formed with at least one hinge (7, 8).

2. A cooling device (1) according to claim 1,
characterized in that
the hinge (7) is secured on a suspension frame (6).

3. A cooling device (1) according to claim 1,
characterized in that
the hinge (8) is secured to an adjacent individual segment (2, 3, 4, 8).

4. A cooling device (1) according to claim 1,
characterized in that
the hinge (7, 8) is formed as a double-joint hinge.

5. A cooling device (1) according to claim 1,
characterized in that
the hinge (7, 8) is formed with a telescopic hinge web (12).

6. A cooling device according to claim 1,
characterized in that
the hinge (7, 8) is formed of a highly refractory material.

7. A method of moving away individual segments (2, 3, 4, 5) of a cooling device (1) for electrodes of a metallurgical furnace such as reduction furnace, electrical arc furnace, induction furnace, etc., which surrounds the electrodes,
characterized in that
at least one individual segment (2, 3, 4, 5) is pivoted away from the electrodes by at least one hinge (7, 8).

8. A method according to claim 7,
characterized in that
the individual segment (2, 3, 4, 5) is pivoted away parallel and/or at an angle.

9. A method according to claim 7,
characterized in that
an individual segment (2, 3, 4, 5) is connected to a suspension frame with at least one hinge (7).

10. A method according to claim 7,
characterized in that
an individual segment (2, 3, 4, 5) is connected to an adjacent individual segment (2, 3, 4, 5) with at least one hinge (8).

11. A method according to claim 7,
characterized in that
two adjacent connected individual segments (2, 3, 4, 5) are pivoted simultaneously.

12. A method according to claim 10,
characterized in that
the inner individual segment (5) is connected with a suspension frame (6) or an adjacent individual segment (4) by at least one hinge (7).

13. A method according to claim 7,
characterized in that
the individual segments (2, 3, 4, 5) are connected with a cooling circuit by flexible conduits.
